(19) United States
(12) Patent Application Publication
(10) Pub. No.: US 2017/0314374 A1
(43) Pub. Date: Nov. 2, 2017

(54) VARIABLE APERTURE FLOW CONTROL MECHANISM FOR GAS LIFT VALVES

(71) Applicant: Cynthia Ann Lundberg, Houston, TX (US)

(72) Inventor: Cynthia Ann Lundberg, Houston, TX (US)

(21) Appl. No.: 15/140,113

(22) Filed: Apr. 27, 2016

(51) Int. Cl. E21B 43/12; E21B 34/10; F16K 31/122; F16K 47/04; F16K 31/126; E21B 34/00

(52) U.S. Cl. CPC E21B 43/123; F16K 47/04; F16K 31/126; E21B 34/10; F16K 31/1221; E21B 2034/007

(57) ABSTRACT

This invention is a flow control mechanism for self-contained Gas Lift Valves (GLVs) for artificial lift of oil or liquid loaded gas wells. This invention is an improvement on what currently exists. Rather than obstruct the flow by partially or fully obstructing a fixed aperture (commonly a stem/ball and seat), where the fluid pressure and dynamic forces affect the actuating force; this invention applies the actuating force to a variable aperture flow control mechanism, for which fluid pressure and dynamic forces do not affect the applied actuating force.

By orienting the fluid pressure gradient and resultant applied force perpendicular to the actuating force and action, fluid throttling by changes in available aperture does not affect the actuating force applied to the variable aperture device. Actuating force is applied vertically while fluid pressure/force acts horizontally. For a three dimensional cylinder construction, actuating force is applied axially while pressure/fluid force acts radially.

### CROSS-REFERENCE TO RELATED APPLICATIONS

This application claims priority under 35 U.S.C. §119(e) from co-pending U.S. Provisional Patent Application No. 62/153,580, by Cynthia Lundberg, “Variable Aperture Flow Control Mechanism for Gas Lift Valves” filed 28 Apr. 2015, which, by this statement, is incorporated herein by reference for all purposes.

### BACKGROUND OF THE INVENTION

The throttling mechanisms of self-contained Gas Lift Valves (GLVs) for artificial of oil or liquid loaded gas wells have either been a fixed aperture design (e.g. orifice or venturi) or have variable throttling by obstructing the fluid flow path through a fixed aperture (e.g. ball and seat), commonly with a gas charged bellows actuating the throttling mechanism.

The fixed aperture design cannot be used as an unloading valve (which requires it lose under certain conditions) and can only be used as an operating valve (continuous injection). The fixed aperture allows only limited flexibility to vary injection flow rate and well conditions without resulting in well instability. For any change in desired injection rate, the optimal solution is a corresponding change in the injection valve aperture; however any fixed aperture valve does not allow this without removal and replacement of the valve.

The variable throttling design utilizes a pressure difference (between bellows charge pressure, injection/casing pressure, or production/tubing pressure) opposed by a spring force (bellows metal spring force and/or coil spring force) to set the throttling device position.

Because the gas flow path is in the same axis as the flow obstructing throttling device (commonly a stem and ball), the gas supply (casing) and production (tubing) pressure affect the net forces applied to the throttling device—and in a varying manner, depending upon the throttling device position (how far open or closed) and the process conditions.

The effectiveness of Gas Lift Valves (GLVs) for artificial lift of oil and liquid loaded gas wells is hampered by the Production Pressure Effect Factor (PPEF) for Injection Pressure Operated (IPO) valves and the Injection Pressure Effect Factor (IPEF) for Production Pressure Operated (PPO) valves. Because current designs utilize an unbalanced (not pressure/force balanced) throttling mechanism, PPEF or IPEF are inherently non-zero and adversely affect the performance of the valves.

Existing designs are inherently unstable during opening and closing, and are not well suited for continuous throttling service. They tend to “pop” open and closed rather than smoothly transition from closed to open, and visa verse.

This invention provides varying flow capacity through varying the flow aperture, without affecting the actuating mechanism pressure/force balance.

### BRIEF DESCRIPTION OF THE DRAWINGS

FIG. 1 illustrates a variable aperture flow control mechanism with a fully open aperture, reduced aperture, and fully closed aperture in accordance with an exemplary embodiment of the invention.

FIG. 2 illustrates a bellows actuated gas lift valve with pressure balanced variable aperture throttling mechanism in accordance with an exemplary embodiment of the invention.

FIG. 2A illustrates the housing of a bellows actuated gas lift valve with pressure balanced variable aperture throttling mechanism in accordance with an exemplary embodiment of the invention.

FIG. 2B illustrates the moving sleeve of a bellows actuated gas lift valve with pressure balanced variable aperture throttling mechanism in accordance with an exemplary embodiment of the invention.

FIG. 3 shows a differential pressure actuated gas lift valve with variable aperture throttling mechanism in accordance with an exemplary embodiment of the invention.

FIG. 3A shows an external view of the housing of a differential pressure actuated gas lift valve with variable aperture throttling mechanism in accordance with an exemplary embodiment of the invention.

FIG. 3B shows an external view of the cage of a differential pressure actuated gas lift valve with variable aperture throttling mechanism in accordance with an exemplary embodiment of the invention.

FIG. 3C shows a cutaway view of the housing of a differential pressure actuated gas lift valve with variable aperture throttling mechanism in accordance with an exemplary embodiment of the invention.

FIG. 3D shows a cutaway view of the cage of a differential pressure actuated gas lift valve with variable aperture throttling mechanism in accordance with an exemplary embodiment of the invention.

FIG. 3E shows a cutaway view of the spring engaging sleeve of a differential pressure actuated gas lift valve with variable aperture throttling mechanism in accordance with an exemplary embodiment of the invention.

### DETAILED DESCRIPTION OF THE INVENTION

This invention is an improvement on what currently exists. The throttling mechanism is oriented such that the size of the aperture through which fluid is directed is varied in proportion to the desired output. The sealing and opening of the aperture is accomplished by an actuating force oriented perpendicularly to the fluid pressure differential created as pressure in the valve is throttled down or up. This minimizes the effect of pressure fluctuations on the opening and closing of the valve, as the fluctuations are no longer directed in opposition to the actuating force.

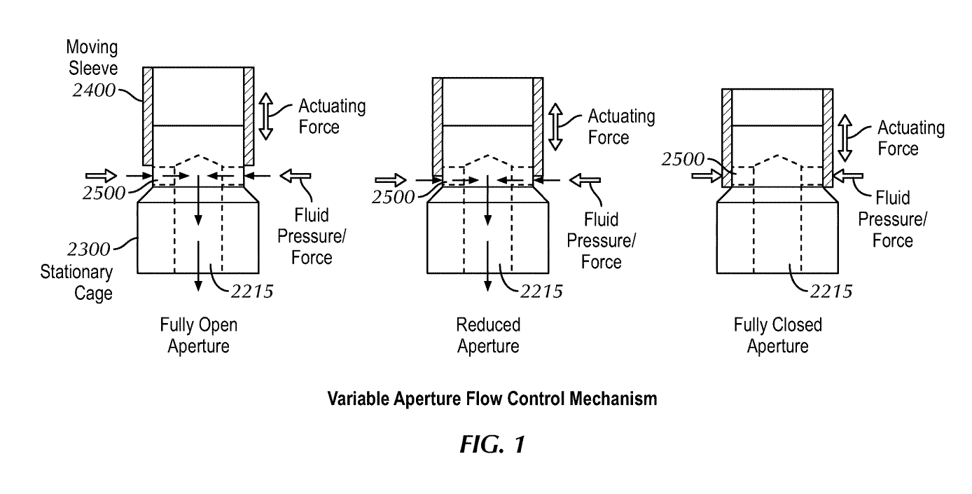

In the orientation of FIG. 1, actuating force is applied vertically while fluid. pressure/force acts horizontally. For a three dimensional cylinder construction, actuating force is applied axially while pressure/fluid force acts radially.

In the embodiment shown, fluid enters the valve by flowing through the variable flow aperture (2500) into the stationary cage (2300) and exiting via the bottom port connection (2215). The variable flow aperture (2500) is throttled via use of a moving sleeve (2400) which is oriented so that its movement is directed perpendicular to the fluid pressure gradient.

### A. Bellows Actuated Valve:

Two embodiments of the innovation employ bellows actuation, where the bellows is exposed to the Injection Pressure [Injection Pressure Operated (IPO) valve] or the bellows is exposed to the Production Pressure [Production Pressure Operated (PPO) valve]. As stated above, the effectiveness of Gas Lift Valves (GLVs) for artificial lift of oil and liquid loaded gas wells is hampered by the Production Pressure Effect Factor (PPEF) for IPO valves and the Injection Pressure Effect Factor (IPEF) for PPO valves.

The sleeve and cage act together to provide a varying aperture available for fluid flow based upon the housing/bellows pressure, unaffected by valve differential pressure. A dynamic seal is created by the inclusion of a vented section between the cage and the housing. The vented section is in communication with the housing and bellows assembly. As the aperture is opened, more fluid exits the aperture, increasing the housing and bellows assembly pressure. From the housing and bellows assembly, fluid flows into the vented chamber. As fluid enters and exits the vented chamber the moving sleeve shifts position, varying the size of the aperture. The end result is a dynamic seal which opens as pressure drops and closes as pressure increases, dynamically throttling the flow of fluid and negating the opposing PPEF or IPEF such that the PPEF or IPEF is effectively zero.

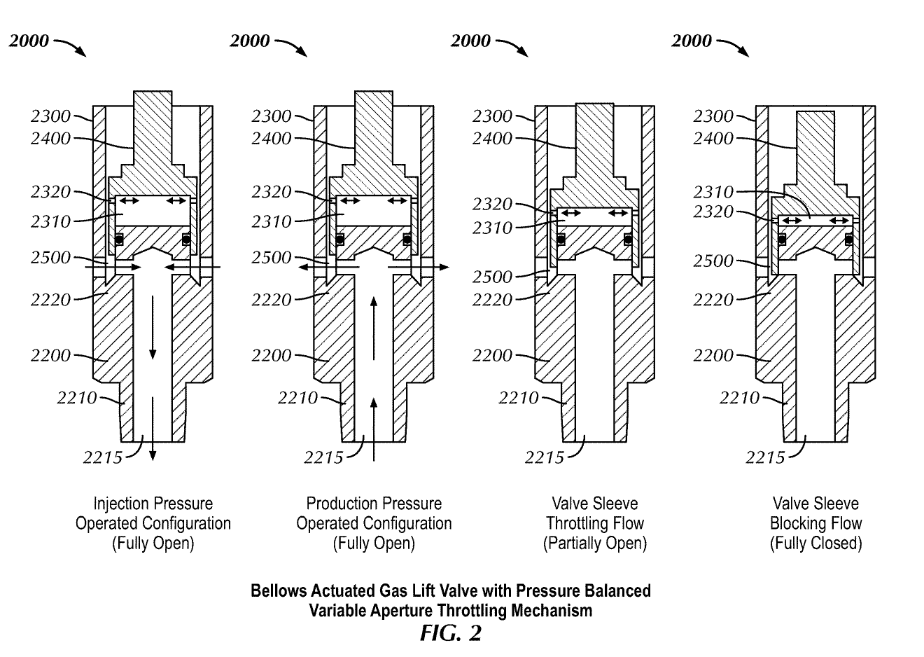

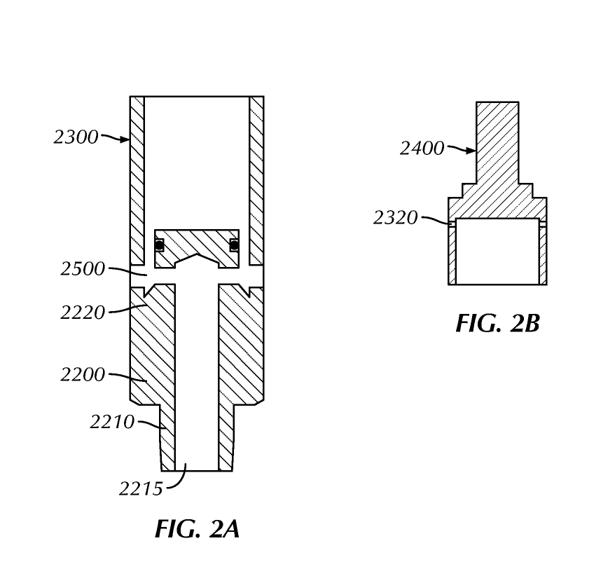

In the embodiment shown, the bellows actuated valve (2000) has a moving sleeve with a bellows connection end (2400) which fits within a housing (2200) having a bottom port connection end (2210). The bottom port connection end also fulfills the function of and serves as a cage (2300). Between the sleeve (2400) and the cage (2300) is a vented volume (2310). The vented volume (2310) is vented to the valve via a venting opening (2320). FIG. 2A shows a cutaway section of the stationary cage and housing (2300 & 2200). FIG. 2B shows a cutaway section of the moving sleeve (2400) including the path (2320) by which the vented volume (7310) vents to the valve.

### B. Differential Pressure/Spring Actuated Valve:

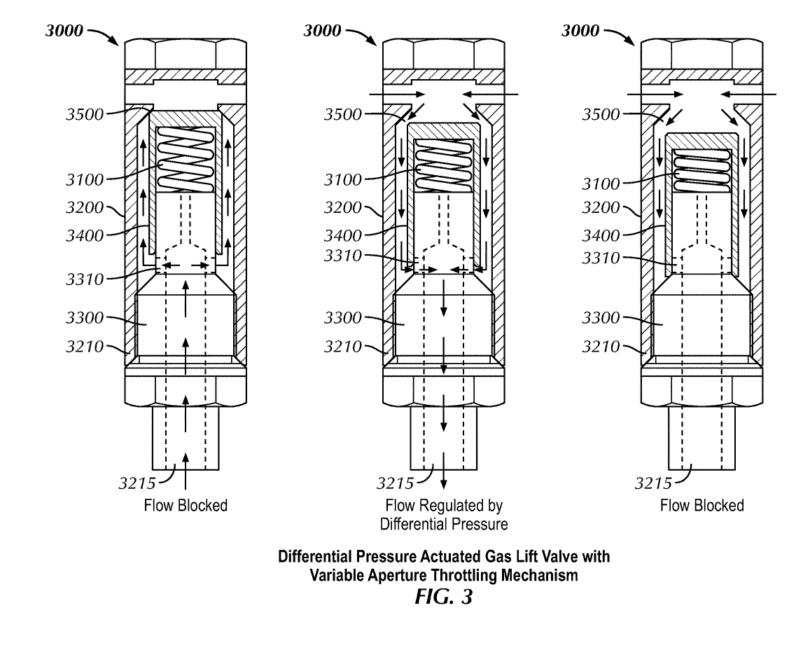

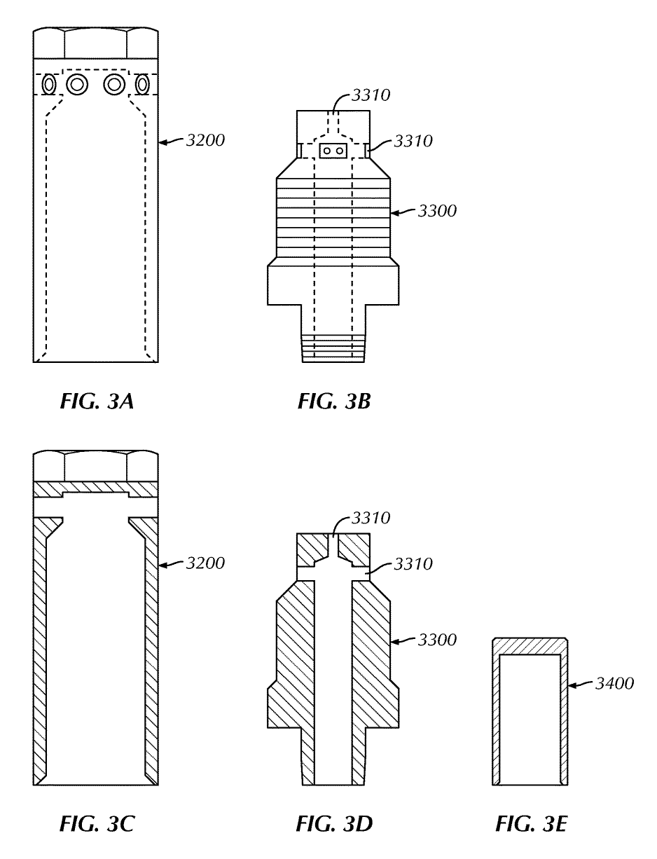

Another variation of this invention is actuation by differential pressure across the valve, opposed by a spring force. In the embodiment shown in FIG. 3, a sleeve containing a compression spring slides over an extension of the stationary cage, varying the aperture available for fluid flow. The inner section of the sleeve is exposed to outlet pressure through a pressure equalizing hole in the stationary cage. High inlet pressure pushes the sleeve downwards, reducing the outlet aperture. The movement of the sleeve to reduce aperture is opposed by the compression coil spring, which is pressed against the stationary cage as the outlet aperture is covered. As such, If inlet pressure is low, the sleeve extends upwards to cover the let aperture, stopping flow until pressure reaches a level sufficient to overcome the spring force. Thus, the sleeve is shunted between covering the inlet aperture and outlet aperture dictated by the pressure differential between the inlet and outlet pressure. Springs with different spring constants or stationary cages of varying dimensions may be used in the valve to dictate the pressure at which flow is throttled. In another embodiment, the spring providing spring force in opposition to the pressure differential may be external to the valve, allowing the use of larger springs which would potentially be too large to fit within the valve.

In the embodiment shown, the spring actuated valve (3000) contains a housing (3200) having a bottom port connection end (3210), where the housing (3200) is connected to a cage (3300) at the bottom port connection end (3210). A spring engaging sleeve (3400) is located within the volume created by the joining of the housing (3200) and the cage (3300). The spring engaging sleeve (3400) contains a compression spring (3100) with a set tension corresponding to the desired throttling effect.

For low or reverse differential pressure applied to the valve, the spring engaging sleeve (3400) contacts the housing (3200) sealing the flow path and preventing flow in the backward direction (back flow). This is a flow checking action.

As pressure differential increases, the flow path is opened and fluid flows through the annulus between the housing (3200) and sleeve (3400), flows through the flow aperture (3310), and exits through a bottom port connection (3215). As pressure differential further increases, the pressure forces compress the spring (3100) and the sleeve lowers in position to reduce the aperture available for the outlet flow path. This is a variable aperture, inversely related to the differential pressure applied. When the pressure differential is high enough to compress the spring (3100) such that the sleeve contacts the base of the cage (3300), the flow path is sealed and outlet flow is blocked.

In another embodiment, the compression spring (3100) controlling the throttling of the valve may be external to the housing (3200), allowing for springs of varying size to be used.

### How to Make the Innovation:

For a cylindrical valve form, construct the flow control mechanism with fluid flow path inward or outward radially and a cylindrical sleeve which moves axially to cover varying portions of the flow path aperture, resulting in an effective variable aperture for flow.

### A. Bellows Actuated Valve:

For a bellows actuated valve, the bellows assembly is connected to the moving cylindrical sleeve. A dynamic seal between the stationary cage and moving sleeve, combined with one or more vent holes above the seal, produces a pressure balance in the axial direction resulting in PPEF or IPEF of zero.

### B. Differential Pressure/Spring Actuated Valve:

For a differential pressure actuated valve, the moving sleeve is constructed with a top seal (no vent hole) and the stationary cage is constructed with a hole which equalizes the pressure under the closed sleeve with the valve outlet pressure. Pressure force acting on the moving sleeve results from the inlet pressure and outlet pressure applied over the sleeve top area. This pressure force is countered by a compression spring, which results in the sleeve axial position proportional to the differential pressure applied divided by the compression spring constant. The resultant aperture available for the flow path is inversely related to the differential pressure, and becomes zero (fully closed) when the force from differential pressure is greater than the force with the spring fully compressed (to sleeve closed position).

### How To Use The Innovation:

### A. Bellows Actuated Valve:

The innovation can be applied to any form of IPO or PPO Gas Lift Valve (tubing retrievable, wireline retrievable, or other variant). The variable aperture flow control mechanism is coupled to any industry standard GLV bellows assembly, with the bellows connected to the moving sleeve to provide actuation.

### B. Differential Pressure Spring Actuated Valve:

The innovation can be used as an unloading gas lift valve, actuated by differential pressure. The purpose of an unloading valve is to inject gas only until conditions are such that a valve lower in the well is capable of injection, at which point the unloading valve should close.

The diagrams in accordance with exemplary embodiments of the present invention are provided as examples and should not be construed to limit other embodiments within the scope of the invention. For instance, heights, widths, and thicknesses may not be to scale and should not be construed to limit the invention to the particular proportions illustrated. Additionally some elements illustrated in the singularity may actually be implemented in a plurality. Further, some element illustrated in the plurality could actually vary in count. Further, some elements illustrated in one form could actually vary in detail. Further yet, specific numerical data values (such as specific quantities, numbers, categories, etc.) or other specific information should he interpreted as illustrative for discussing exemplary embodiments. Such specific information not provided to limit the invention.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A gas lift valve, wherein the flow of fluid is throttled via an actuating force oriented such that it is substantially perpendicular to the path of gas flow.

2. A gas lift valve as in claim 1, wherein the flow of fluid is throttled via use of a moveable covering which moves to cover the aperture to a variable degree in proportion to desired pressure.

3. A gas lift valve as in claim 2, wherein the moveable covering is actuated by use of a bellows.

4. A gas lift valve as in claim 2, wherein the moveable covering is dynamically sealed against a stationary cage, and a vented section is present between the covering and the cage such that variations in pressure entering and exiting the valve are minimized by opposing pressure created within the vented section.

5. A gas lift valve as in claim 1, wherein the valve is throttled by use of a compression spring.

6. A gas lift valve as in claim 1, wherein the pressure differential between the inlet pressure and outlet pressure is used as the actuating force to throttle gas flow.

7. A gas lift valve as in claim 6, wherein the throttling is accomplished by varying the size of a flow aperture inversely to the differential pressure.

8. A gas lift valve comprising;
a variable flow aperture; and
a compression spring,
wherein the compression spring provides a spring force which acts as an actuating force reduce the size of the variable flow aperture as the pressure exerted in opposition to the spring force increases.

9. A gas lift valve as in claim 8 further comprising;
a spring engaging sleeve, wherein the spring engaging sleeve encloses the compression spring;
a cage, wherein the cage has a pressure equalizing hole allowing communication between the spring engaging sleeve and the valve outlet.

10. A gas lift valve comprising
a valve housing; and
a moveable covering
wherein a vented section is present between the valve housing and the moveable covering such that variations in pressure entering and exiting the valve are minimized by opposing pressure created within the vented section.

11. A gas lift valve as in claim 10 wherein the actuating force is provided by a bellows.

12. A gas lift valve as in claim 10 wherein the vented section is exposed to the pressure of fluid exiting the valve through the aperture.

13. A gas lift valve, wherein the flow of fluid is throttled by varying the size of an aperture through which fluid travels.

14. A gas lift valve as in claim 13, wherein the sealing of the aperture is accomplished by a force directed substantially perpendicular to the flow of fluid through the aperture.
